(19) United States
(12) Patent Application Publication
(10) Pub. No.: US 2016/0096181 A1
(43) Pub. Date: Apr. 7, 2016

(54) POWDER PROCESSING APPARATUS

(71) Applicant: NARA MACHINERY CO., LTD., Tokyo (JP)

(72) Inventors: Hidetoshi IWAMATSU, Tokyo (JP); Kenichi JOHARA, Tokyo (JP)

(21) Appl. No.: 14/967,743

(22) Filed: Dec. 14, 2015

Related U.S. Application Data
(63) Continuation of application No. PCT/JP2014/003111, filed on Jun. 11, 2014.

(30) Foreign Application Priority Data
Jun. 20, 2013 (JP) 2013-129339

(51) Int. Cl. B02C 19/00; B02C 13/26

(52) U.S. Cl. CPC B02C 19/0018; B02C 13/26

(57) ABSTRACT

A powder processing apparatus includes a rotor 5, multiple impact pins, and a collision ring 8. The rotor rotates around a horizontal shaft. The impact pins are radially attached on a front surface of the rotor 5. The collision ring 8 covers a side surface of the rotor 5 in which the impact pins are attached and is peripherally disposed along an outermost raceway surface of the impact pins. A part of members (a detachable portion 6b) included in the impact pin is detachably attached to the other (a fixing portion 6a). Multiple types of the detachable parts are prepared to adjust a distance between the impact pins and the collision ring 8.

### CROSS-REFERENCE TO RELATED APPLICATIONS

This application is a continuation application of International Patent Application No. PCT/JP2014/003111 filed on Jun. 11, 2014, which claims priority to Japanese Patent Application No. 2013-129339 filed on Jun. 20, 2013 in Japan, the contents of which are hereby incorporated by reference in their entirety.

### BACKGROUND OF INVENTION

1. Field of the Invention

The present invention relates to a powder processing apparatus.

2. Background Art

Conventionally, as disclosed in Patent Literature 1, a powder processing apparatus is proposed in which, by using an impact type striking means, a fine solid particle is embedded or fixed on the other solid particle, or a fine solid particle is fixed in a membranous on a surface of the other solid particle. Then, a surface modification process is carried out to the solid particle, and also a spheroidization process is carried out to an irregular particle such as metal and resin.

### CITATION LIST

### Patent Literature

Patent Literature 1: JP 06-55053 A

Operation conditions of a powder processing apparatus need to be set so that such as ambient temperature in an impact chamber is balanced with physical properties of powder to be processed.

### SUMMARY OF INVENTION

One or more embodiments of the present invention are directed to a powder processing apparatus capable of easily obtaining an operation condition in which such as ambient temperature in an impact chamber is balanced with physical properties of powder to be processed.

A powder processing apparatus according to one or more embodiments of the present invention includes a rotor, multiple impact pins, and a collision ring. The rotor rotates around a horizontal shaft. The impact pins are radially attached on a front surface of the rotor, each of the impact pins having a blade shape. The collision ring covers a side surface of the rotor in which the impact pins are attached and is peripherally disposed along an outermost raceway surface of the impact pins.

Apart of members included in the impact pin is detachably attached to the other included in the impact pin, which is fixed to the rotor. The part of the members is exchangeable with other type(s) of detachable part, to adjust a distance between the impact pins and the collision ring.

Or, an impact pin group integrating the impact pins is detachably attached to the rotor. The impact pin group is exchangeable with other type(s) of impact pin group, to adjust a distance between the impact pins and the collision ring.

By replacing the detachable portion or the impact pin group, a distance (clearance) between the impact pin and the collision ring can be adjusted. Therefore, operation conditions can be easily found in which such as ambient temperature in an impact chamber is balanced with physical properties of powder to be processed.

In one or more embodiments of the present invention, the impact pin includes a fixing portion and a detachable portion. The fixing portion is fixed to the rotor. The detachable portion is detachably attached to the fixing portion. The detachable portion is the part of members included in the impact pin. The fixing portion is the other included in the impact pin. The detachable portion is exchangeable with other type (s) of detachable portion having different length in a radial direction of the rotor.

A tip portion of the impact pin (a portion near the collision ring) is easy to be abraded. However, the abraded portion is configured by the detachable portion detachable from the fixing portion fixed to the rotor, and therefore only the abraded portion can be replaced. Further, wear and abrasion resistance can be improved by using ceramics, a hard metal, or a refractory metal in a material of the detachable portion.

In one or more embodiments of the present invention, the fixing portion extends parallel to an axial direction of a rotating shaft of the rotor and includes a groove engaged with the detachable portion, and the groove has a sectional shape in which an opening is narrower than a bottom.

The detachable portion is attached to the fixing portion by engaging with the groove. Therefore, at least, it is prevented that the detachable portion is detached in a radial direction.

Further, in one or more embodiments of the present invention, a cooling mechanism is provided in the rotor and the fixing portion.

Due to such a configuration, i.e., the cooling mechanism provided in the fixing portion of an impact pin in addition to the rotor, in comparison with the case where the cooling mechanism is not provided in the fixing portion, increase of ambient temperature in an impact chamber and a circulation circuit can be efficiently suppressed.

Further, in one or more embodiments of the present invention, an impact pin group is formed in which one ends of the multiple impact pins are fixed to an impact pin fixing member. The impact pin fixing member is detachably attached to the rotor. The impact pin group is exchangeable with other type(s) of impact pin group in which the impact pins have different lengths in a radial direction of the rotor.

The impact pin fixing member is attached to the rotor by screwing in an axial direction parallel to the rotating shaft and firmly fixed since a large screw can be used in comparison with the case where the detachable portion is attached to the fixing portion by screwing in a radial direction.

Further, the impact pin group in which multiple impact pins are integrated by being fixed to the impact pin fixing member can be attached to and detached from the rotor in a state in which the rotor is attached to the rotating shaft. Therefore, attachment/detachment can be easily operated in comparison with the case where each detachable portion is attached to each fixing portion after the rotor is detached from the rotating shaft.

Further, since the rotor rotates at a high speed, a static balance and a dynamic balance need to be kept to minimize vibration of an apparatus. In the case where each detachable portion is attached to each fixing portion after the rotor is detached from the rotating shaft, even if the balance is kept in a state in which the detachable portion is once attached to the fixing portion, the detachable portion needs to be attached to the same fixing portion as before in the case where the same detachable portion is again used after once being detached. Therefore, parts can be easily managed and handled in the case where multiple impact pins are integrally fixed to an impact pin fixing portion.

Further, in one or more embodiments of the present invention, each one ends of the impact pins on a side opposite to a side facing the rotor is fixed to a fixing ring.

As described above, according to one or more embodiments of the present invention, a powder processing apparatus is capable of easily obtaining operation conditions in which such as ambient temperature in an impact chamber is balanced with physical properties of powder to be processed.

### BRIEF DESCRIPTION OF DRAWINGS

FIG. 1 is an elevation view illustrating a configuration of a powder processing apparatus according to embodiments described herein and peripheral devices thereof.

FIG. 2 is a sectional configuration view in the case where the powder processing apparatus according to a first embodiment is viewed from a front surface.

FIG. 3 is a sectional configuration view in the case where the powder processing apparatus according to the first embodiment is viewed from a side surface.

FIG. 4 is a sectional configuration view in the case where a powder processing apparatus in which a second jacket is provided is viewed from a side surface.

FIG. 5 is an enlarged sectional configuration view of a main portion of FIG. 4.

FIG. 6 is a perspective view indicating a positional relation between an impact pin and a collision ring before one of detachable portions according to the first embodiment is attached to a fixing portion.

FIG. 7 is an enlarged perspective view of a main portion of FIG. 6.

FIG. 8 is sectional configuration views of three types of detachable portions having different tip heights.

FIG. 9 is a perspective view indicating a positional relation between an impact pin and a collision ring after the detachable portion according to the first embodiment is attached to the fixing portion.

FIG. 10 is a sectional configuration view in the case where a powder processing apparatus according to a second embodiment is viewed from a front surface.

FIG. 11 is a sectional configuration view in the case where the powder processing apparatus according to the second embodiment is viewed from a side surface.

FIG. 12 is a perspective view indicating a positional relation between an impact pin group and a collision ring before an impact pin group according to the second embodiment is attached to the rotor.

FIG. 13 is a perspective view indicating a positional relation between an impact pin group and a collision ring after the impact pin group according to the second embodiment is attached to the rotor.

FIG. 14 is a perspective view indicating a positional relation between an impact pin group and a collision ring before an impact pin group with a two-divided structure is attached to the rotor.

FIG. 15 is a perspective view indicating a positional relation between an impact pin group and a collision ring before those are attached to the rotor, in the case where an impact pin group has a two-divided structure, and portions contacting a first fixing ring member and a second fixing ring member are partially overlapped each other in an axial direction.

FIG. 16 is a perspective view indicating a positional relation between an impact pin group and a collision ring before the impact pin group interdigitated with a two-divided structure is attached to the rotor.

### DETAILED DESCRIPTION

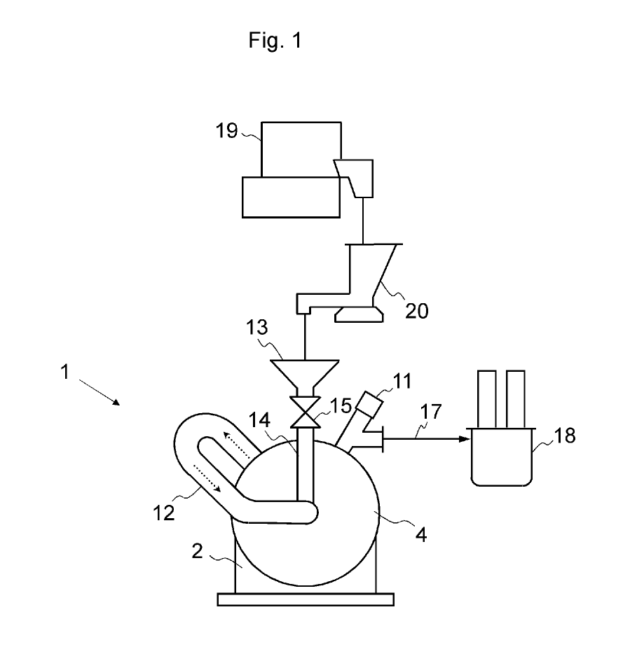

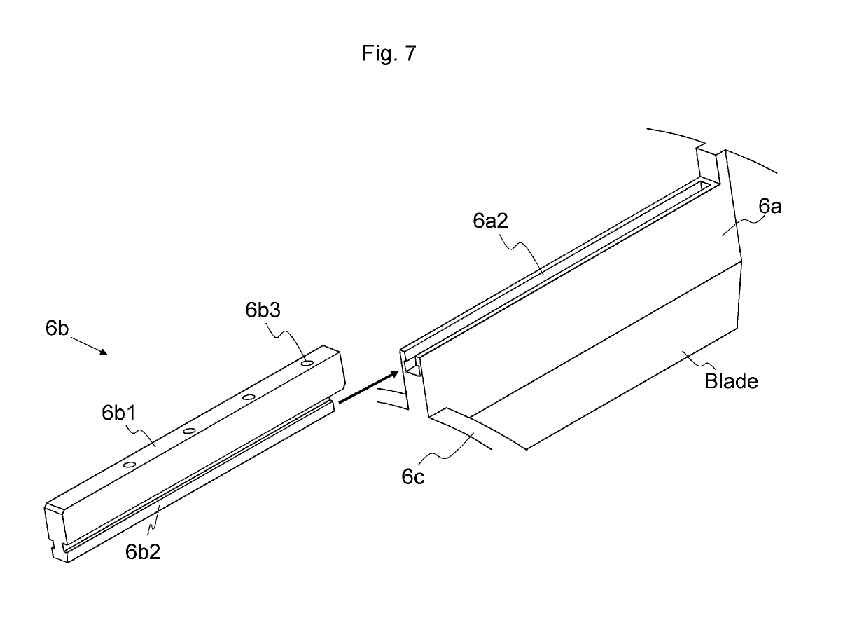

Embodiments will be described below with reference to drawings. A powder processing apparatus 1 according to a first embodiment includes a main body casing 2, a rear cover 3, a front cover 4, a rotor 5, an impact pin 6, a rotating shaft 7, and a collision ring 8 (see FIGS. 1 to 9).

The rotor 5 has a disc shape and rotates around the rotating shaft 7 extending in a substantially horizontal direction at a high speed in an impact chamber A which is a space surrounded by the rear cover 3, the front cover 4, and the collision ring 8.

The impact pin 6 has a blade shape, and multiple impact pins 6 are radially attached at predetermined intervals on a front surface of the rotor 5. In the first embodiment, the impact pin 6 includes a fixing portion 6a and a detachable portion 6b. The fixing portion 6a has a substantially trapezoidal column shape, and a width is reduced toward a center of the rotating shaft 7. The detachable portion 6b is detachably attached to the fixing portion 6a. The fixing portion 6a is attached to the rotor 5 by welding.

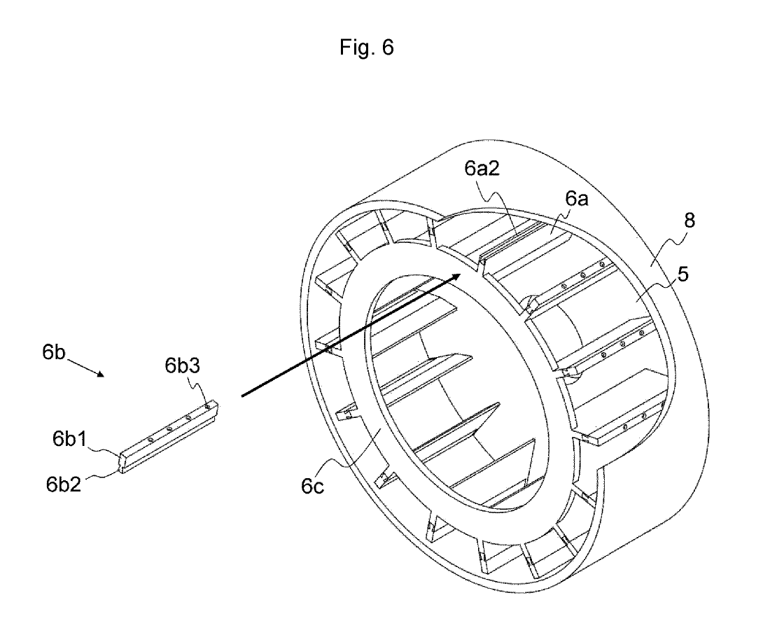

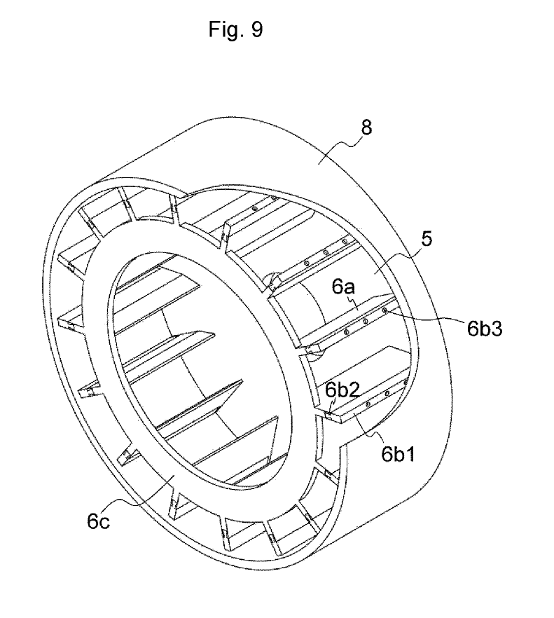

In the case where a longitudinal length parallel to an axial direction of the rotating shaft 7 of the fixing portion 6a is long, to prevent that an outermost raceway surface of an end portion comes into contact with an inner peripheral surface of the collision ring 8 (in some cases, an outer peripheral portion of the rotor 5 is warped in a direction of the rear cover 3) since the end portion on a side opposite to an end of the fixing portion 6a fixed to the rotor 5 is bent in a radial direction by centrifugal force generated by a high speed rotation of the rotor 5, the end portion on the side opposite to the end of the fixing portion 6a fixed to the rotor 5 is preferably fixed to the fixing ring 6c as illustrated in FIGS. 6 and 9.

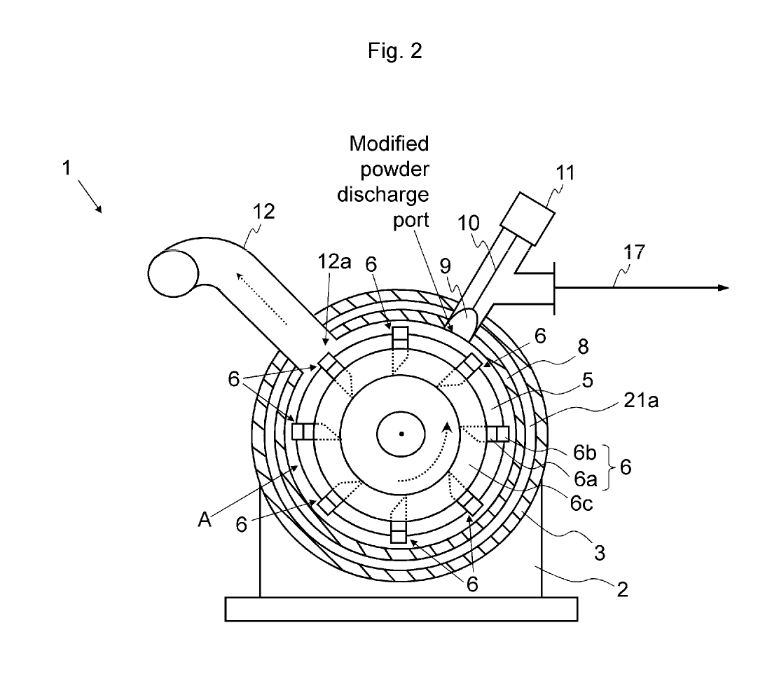

FIG. 2 illustrates an example (a middle-sized apparatus) in which eight impact pins 6 are attached to the rotor 5 to specifically indicate an internal structure of the powder processing apparatus 1. FIGS. 6 and 9 illustrate examples (a large-sized apparatus, as the apparatus becomes large, the impact pins are increased), in which sixteen impact pins 6 are attached to the rotor 5 to specifically indicate a structure of the impact pin 6.

A groove 6a2 is provided on an outermost raceway surface of the fixing portion 6a. The groove 6a2 extends in a longitudinal direction parallel to an axial direction of the rotating shaft 7 and has a substantially dovetail groove shape in which a projected portion (tenon) provided in a longitudinal direction of the detachable portion 6b is engaged. The substantially dovetail groove shape according to the first embodiment is not limited to a trapezoidal shape in which a sectional surface is opened on an upper side and includes a groove shape in which an opening is narrower than a bottom such as a projected shape in which a sectional surface is opened at an upper portion (a projected portion at a center). Multiple tap holes 6a3 (not illustrated) are cut in the groove 6a2 to fix the detachable portion 6b.

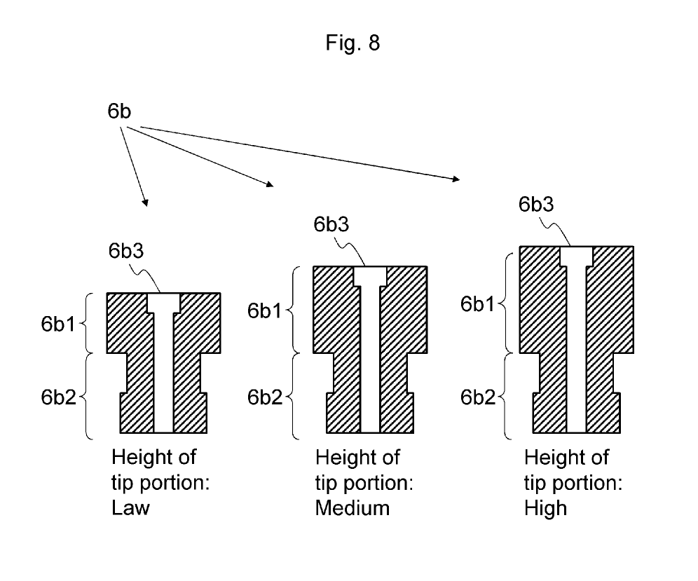

A tip portion 6b1 and an engaging portion 6b2 are integrally included in the detachable portion 6b. The tip portion 6b1 has a rectangular parallelepiped shape in which a length in a longitudinal direction (axial direction) and a width (thickness) are almost the same as those of the fixing portion 6a. The engaging portion 6b2 has almost the same shape as the groove 6a2. Multiple types of the detachable portions 6b are prepared in which the height of a substantially rectangular parallelepiped shape forming the tip portion 6b1 (length in a radial direction of a disc included in the rotor 5) is different (see FIG. 8). Multiple types (for example, 6 types by 5 mm) of the detachable portions 6b are prepared so that an interval between an outermost raceway surface of the impact pin 6 and the collision ring 8 becomes, for example, 5 to 30 mm, when the detachable portion 6b is attached to the fixing portion 6a, although it depends on an apparatus size.

Further, in the detachable portion 6b, screw holes 6b3 are provided in the same number as the above tap holes 6a3 at positions corresponding to the tap holes 6a3. The screw holes 6b3 penetrate the tip portion 6b1 and the engaging portion 6b2 in a height direction of the rectangular parallelepiped shape. The detachable portion 6b is attached to the fixing portion 6a by sliding the engaging portion 6b2 of the detachable portion 6b in an axial direction and sliding the engaging portion 6b2 into the groove 6a2 of the fixing portion 6a, and the detachable portion 6b is fixed to the fixing portion 6a by inserting such as a bolt with a hexagonal hole (not illustrated) into the screw hole 6b3 of the detachable portion 6b and tightening the bolt into the tap hole 6a3 of the groove 6a2.

The length of the impact pin 6 in a radial direction can be adjusted by detachably attaching the detachable portion 6b to the fixing portion 6a. Therefore, an interval between a tip (a side opposite to the fixing portion 6a) of the detachable portion 6b and the collision ring 8 can be adjusted by choosing the detachable portions 6b having different heights.

The collision ring 8 has a substantially cylindrical shape surrounding the rotor 5 and the impact pin 6. The collision ring 8 is peripherally disposed along an outermost raceway surface of the detachable portion 6b attached to the fixing portion 6a and disposed at constant intervals with respect to the detachable portion 6b.

Next, other members of the powder processing apparatus 1 and peripheral devices will be described. A modified powder discharge port is provided by partially cutting an upper portion of the collision ring 8. A discharge port opening/closing valve 9 closely contacting with and fitting to the modified powder discharge port is provided to the modified powder discharge port. Further, a valve shaft 10 of the discharge port opening/closing valve 9 and an actuator 11 driving and operating the discharge port opening/closing valve 9 via the valve shaft 10 are provided to the modified powder discharge port. A powder collector (solid-gas separator) 18 such as a bag collector is provided via a modified powder discharge pipe 17 in a downstream of the discharge port opening/closing valve 9.

In addition, a circulation circuit 12, a material hopper 13, a material supply chute 14, and a supply port opening/closing valve 15 are also provided. The circulation circuit 12 forms a closed circuit by communicating an inlet 12a opening at a part of the collision ring 8 and an outlet 12b opening at a position facing a center portion of the rotor 5 in the front cover 4. The material supply chute 14 communicates the material hopper 13 and the circulation circuit 12. The supply port opening/closing valve 15 is provided in the midstream of the material supply chute 14.

At an upstream of the material hopper 13, a preprocessor 19 and a material weighing feeder 20 are provided. Examples of the preprocessor 19 include each type of mixers or an automatic mortar to be used in the case where mixed powder (ordered mixture), in which fine particles are preliminarily adhered to core particles in advance, needs to be adjusted. The material weighing feeder 20 supplies a fixed quantity of the mixed powder obtained by the preprocessor 19 to the powder processing apparatus 1.

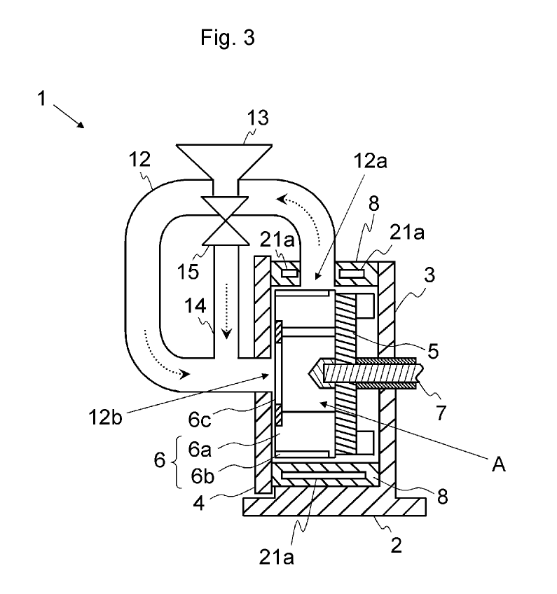

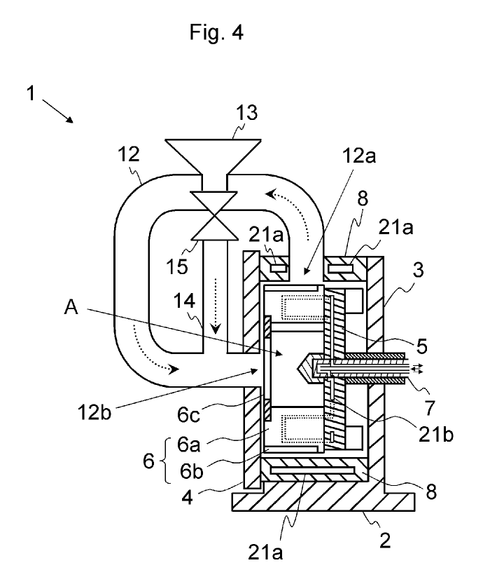

To suppress an increase of ambient temperature in the impact chamber A and the circulation circuit 12 of the powder processing apparatus 1, a jacket structure (a first jacket 21a) is applied to the inside of members (the rear cover 3, the front cover 4, and the collision ring 8) surrounding the impact chamber A, and a jacket structure with a double pipe structure (not illustrated) is applied to the circulation circuit 12, and a refrigerant such as cooling water may flow in the jacket structure. FIGS. 3 and 4 illustrate examples in which the jacket structure (the first jacket 21a) is provided in the collision ring 8.

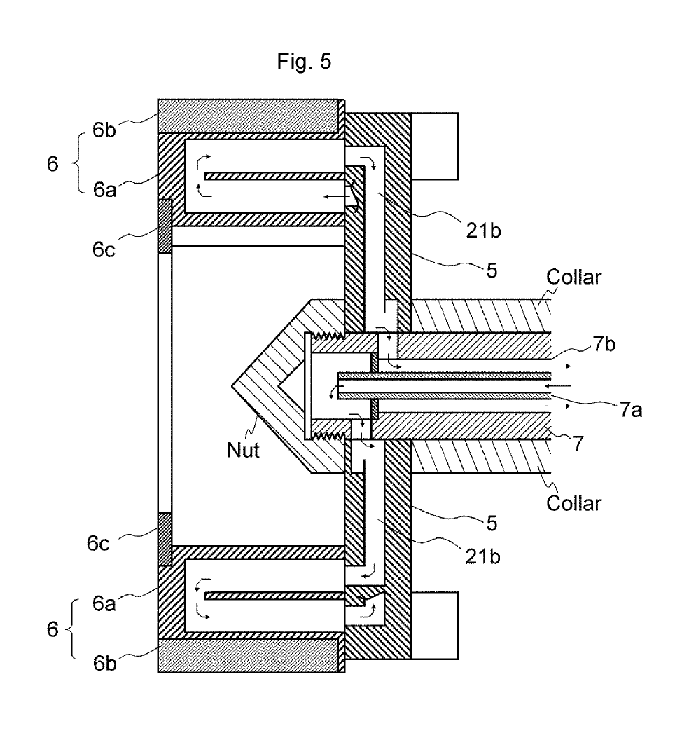

Further, a refrigerant passage (a second jacket 21b) is formed in the rotor 5 and the fixing portion 6a of the impact pin 6 fixed to the rotor 5, and refrigerant such as cooling water may flow in the refrigerant passage (see FIGS. 4 and 5). Specifically, the rotating shaft 7 has a hollow structure, and a cylindrical water pipe 7a is inserted in the rotating shaft 7, and a gap between the rotating shaft 7 and the water pipe 7a is a discharge channel 7b. In the rotor 5, a ring-shaped space (circulating water channel) and a space (a water channel and a discharge channel) are provided. The ring-shaped space is formed in an outer peripheral portion (a portion contacting with a passage of the fixing portion 6a) of the rotor 5 around a rotating shaft. The space is, for example two pairs and four channels, and is formed perpendicular to the rotating shaft and extends in a radial direction to the ring-shape space. One end of the water channel communicates with the water pipe 7a via an opening of the rotating shaft 7. One end of the discharge channel communicates with the discharge channel 7b via another opening of the rotating shaft 7. A circulating water channel as illustrated in FIGS. 4 and 5 is provided in the fixing portion 6a. Accordingly, a water channel of a refrigerant is formed as follows: the water pipe 7a→the water channel in the rotor 5→the circulating water channel in the rotor 5→the circulating water channel in the fixing portion 6a→the circulating water channel in the rotor 5→the discharge channel in the rotor 5→the discharge channel 7b.

In the present embodiment, the second jacket 21b is used for a cooling mechanism. Due to the configuration, i.e. the second jacket 21b as the cooling mechanism provided in the fixing portion 6a of the impact pin 6 in addition to the rotor 5, in comparison with the case where the cooling mechanism is not provided in the fixing portion 6a, increase in the ambient temperature in the impact chamber A and the circulation circuit 12 can be efficiently suppressed.

A surface modification procedure of solid particles using the powder processing apparatus 1 according to the first embodiment will be described in an example in which fine particles are fixed on surfaces of core particles. First, the rotor 5 in which the detachable portion 6b is fixed to the fixing portion 6a is attached to the rotating shaft 7 and fixed by a nut, and the front cover 4 is closed. Then, a refrigerant, for example cooling water, is flowed in the first jacket 21a and the second jacket 21b at a constant flow.

The supply port opening/closing valve 15 provided in the midstream of the material supply chute 14 is closed, and the discharge port opening/closing valve 9 of the modified powder discharge port is also closed. Then, the rotating shaft 7 is rotated by a driving means (not illustrated) and, for example, the rotor 5 is rotated at a peripheral speed of approximately 80 m/sec. At this time, rapid air flow is generated in association with rotation of the impact pin 6. By a fan effect based on centrifugal force of the air flow, circulating flow is formed from the inlet 12a opening at the part of the collision ring 8 to the impact chamber A, via the circulation circuit 12 and the outlet 12b opening at the position facing the center of the rotor 5 in the front cover 4. In other words, perfect self circulating flow is formed.

A circulating air volume per unit time generated in this case is remarkably large in comparison with a total volume of an impact chamber and a circulating system. Therefore, enormously frequent air circulation cycles can be formed in a short time.

After the circulating flow is formed, when the supply port opening/closing valve 15 is opened, and mixed powder of core particles and fine particles is put into the material hopper 13 via the material weighing feeder 20, the mixed powder enters into the impact chamber A via the material hopper 13 and the material supply chute 14. After that, the supply port opening/closing valve 15 is closed.

The mixed powder introduced in the impact chamber A receives a momentary striking action by the impact pin 6 provided to the rotor 5 rotating in the impact chamber A at a high speed, and further the mixed powder collides with the peripheral collision ring 8. Then, the mixed powder again returns to the impact chamber A with the circulation air flow through the circulation circuit 12, and again receives a similar striking action. By repeatedly receiving the striking action, uniform fixing process (fixation of fine particles on surfaces of core particles) is performed in a short time, and composite particles in which fine particles are firmly fixed on surfaces of core particles are obtained.

After the fixing process is finished, the discharge port opening/closing valve 9 of the modified powder discharge port is moved and is opened, and the composite particles are discharged. The composite particles are discharged by centrifugal force acting on the composite particles themselves and are collected by the powder collector 18 via the modified powder discharge pipe 17.

Mixed powder flows in the circulation circuit 12 and the impact chamber A accompanied by circulating flow of air. However, the powder processing apparatus 1 is a batch type apparatus. A quantity of the mixed powder to be processed in one batch operation is determined by a volume between an outermost raceway surface (of the detachable portion 6b) of the impact pin 6 in the impact chamber A and the collision ring 8, and is more specifically determined by a distance (clearance) between an outermost raceway surface of the impact pin 6 and the collision ring 8.

Therefore, even if a quantity of mixed powder to be put into the impact chamber A, specifically a quantity of mixed powder to be prepared in one batch operation, is increased up to a certain quantity, a load current value is not significantly increased. However, when the quantity exceeds the certain quantity, the load current value is rapidly increased, and ambient temperature in the impact chamber is increased. Therefore, for example, in the case where toner particles weak to heat is processed, the toner particles might be melted and adhered to the impact pin 6, the collision ring 8, and an inner surface of the circulation circuit 12, and the quality of the toner particles might be deteriorated.

By using the detachable portion 6b having a short height, throughput in one batch operation can be increased when a distance between an outermost raceway surface of the impact pin 6 and the collision ring 8 is increased, and also a rapid increase in ambient temperature in the impact chamber A can be suppressed. Further, an impact force to be applied to mixed powder is basically determined by a rotation speed of the rotor 5 (a peripheral speed on an outermost raceway surface of the impact pin 6). However, as the above clearance is increased, the impact force is reduced, and therefore, to obtain the same quality of processed powder as the quality of powder processed by an apparatus with a general clearance, a process time for one batch operation needs to be extended.

To adjust the above clearance, there is a method to prepare multiple types of the rotors 5 in which an outer diameter (a diameter of an outermost raceway surface of the impact pin 6) is different and/or the collision ring 8 in which an inner diameter is different. However, it is extremely difficult to replace the collision ring 8 due to relations with the main body casing 2, the front cover 4, and the rear cover 3. In the case where an outer diameter of the rotor 5 is changed, multiple rotors 5 need to be prepared in which the impact pins 6 weighing several tens to hundreds of kilograms are attached, and it is not preferable from viewpoints of production cost and replacing workability. In the first embodiment, the above clearance can be easily adjusted by replacing the detachable portions 6b having different lengths in height direction for use.

Further, a process state of powder to be processed differs depending on physical properties of each powder to be processed. Therefore, operation conditions need to be balanced in accordance with the physical properties of each powder to be processed and an object of processing.

Therefore, a similar operation is performed by changing throughput (a quantity to be prepared in one batch operation) and a process time of mixed powder, and attaching the detachable portions 6b having different lengths in height direction. Accordingly, optimum operation conditions are found by confirming a change (whether there is a change in quality) in a process state and physical properties of composite particles, a change in ambient temperature in the impact chamber A, and also whether the composite particles (or core particles and fine particles which are raw materials therefor) are adhered to the impact pin 6, the rotor 5, the collision ring 8, and an inner surface of the circulation circuit 12.

In the first embodiment, by replacing the detachable portions 6b having different lengths in height direction, a distance (clearance) between an outermost raceway surface of the impact pin 6 and the collision ring 8 can be adjusted. Therefore, operation conditions can be easily found in which such as ambient temperature in an impact chamber is balanced with physical properties of powder to be processed.

Further, the detachable portions 6b having the same height sizes are not necessarily attached to every fixing portions 6a. In accordance with a type of powder to be processed and an object of processing, the impact pin 6 may include both of the fixing portion 6a in which the detachable portion 6b having a long length in a height direction (radial direction of the rotor 5) is attached and the fixing portion 6a in which the detachable portion 6b having a short length in a height direction (radial direction of the rotor 5) is attached. To keep balance of the rotor 5, the detachable portions 6b having the same lengths in a height direction (radial direction of the rotor 5) are preferably attached to the fixing portions 6a positioned point-symmetrically.

Further, a tip portion of the impact pin 6 (a portion near a collision ring 8) is easy to be abraded. However, the abraded portion is configured by the detachable portion 6b detachable from the fixing portion 6a fixed to the rotor 5, and therefore only the abraded portion can be replaced. Furthermore, wear and abrasion resistance can be improved by using ceramics, a hard metal, or a refractory metal in a material of the detachable portion 6b.

The detachable portion 6b is attached to the fixing portion 6a by engaging the engaging portion 6b2 to the groove 6a2. Therefore, at least, it is prevented that the detachable portion 6b is detached in a radial direction.

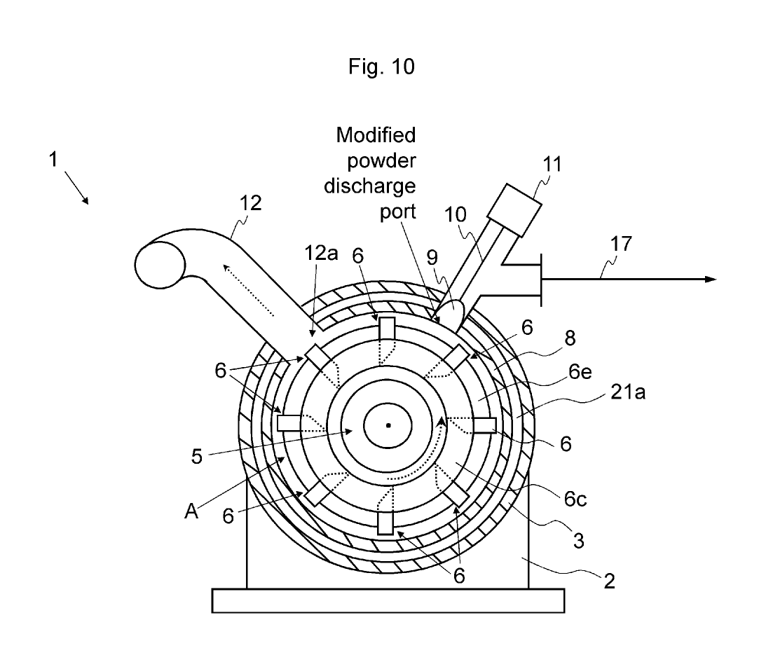

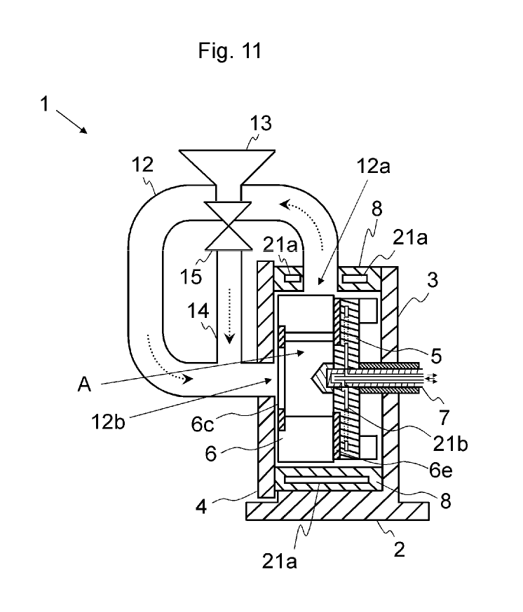

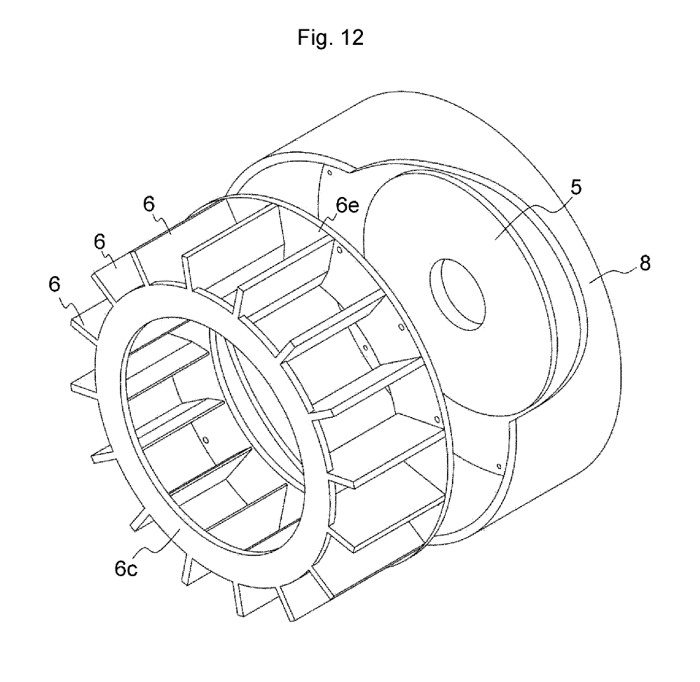

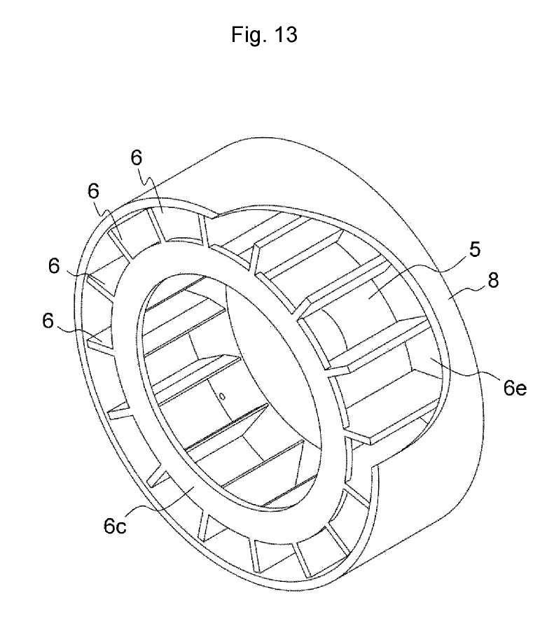

In the first embodiment, a part of the members included in the impact pin 6 (the detachable portion 6b) is detachably attached to the other (the fixing portion 6a), and multiple types of the detachable portions 6b having different lengths in a height direction (radial direction of the rotor 5) are prepared to adjust a distance between the impact pin 6 and the collision ring 8. A second embodiment is considered in which an impact pin group integrating multiple impact pins 6 is detachably attached to the rotor 5, and multiple types of the impact pin groups in which the impact pins have different lengths in a height direction (radial direction of the rotor 5) are prepared to adjust a distance between the impact pin 6 and the collision ring 8 (FIGS. 10 to 13).

In the second embodiment, by replacing the impact pin group having different lengths in a height direction (radial direction of the rotor 5), a distance (clearance) between an outermost raceway surface of the impact pin 6 and the collision ring 8 can be adjusted. Therefore, operation conditions can be easily found in which such as ambient temperature in an impact chamber is balanced with physical properties of powder to be processed.

Specifically, an impact pin group is formed in which an end of the impact pin 6 on a side facing the rotor 5 is fixed to an impact pin fixing ring 6e, and the impact pin fixing ring 6e is detachably attached on a front surface of the rotor 5. Multiple types of the impact pin groups are prepared in which the impact pins 6 are fixed to the impact pin fixing ring 6e and have different radial lengths. Further, as with the first embodiment, in the case where a longitudinal length parallel to an axial direction of the impact pin 6 is long, an end portion of the impact pin 6 on a side opposite to a side fixed to the impact pin fixing ring 6e is preferably fixed to the fixing ring 6c. In the second embodiment, a passage of a refrigerant (the second jacket 21b) is formed only in an inside of a disc of the rotor 5.

The impact pin fixing ring 6e is attached to the rotor 5 by screwing in an axial direction parallel to the rotating shaft 7 and firmly fixed since a large screw can be used in comparison with the first embodiment in which the detachable portion 6b is attached to the fixing portion 6a by screwing in a radial direction.

A front surface of the rotor 5 is preferably formed in a disc-shaped projected portion in which an inner diameter of the impact pin fixing ring 6e is an outer diameter and which has the same thickness as the impact pin fixing ring 6e. Specifically, the projected portion and a round notch at a center of the impact pin fixing ring 6e has a spigot structure, and the both of them can be fixed and positioned easily.

Further, one impact pin group in which every impact pins 6 are integrated by being fixed to the impact pin fixing ring 6e can be attached to and detached from the rotor 5 in a state in which the rotor 5 is attached to the rotating shaft 7. Therefore, attachment/detachment can be easily operated in comparison with the first embodiment in which each detachable portion 6b is attached to each fixing portion 6a after the rotor 5 is detached from the rotating shaft 7.

Furthermore, an interval between an outermost raceway surface of the impact pin 6 and the collision ring 8 is the same as the interval according to the first embodiment. The impact pin group may integrate the impact pins 6 by including both of the impact pins 6 having long lengths in a height direction (radial direction of the rotor 5) and the impact pins 6 having short lengths in a height direction (radial direction of the rotor 5) and fixing them to the impact pin fixing ring 6e.

Further, the rotor 5 rotates at a high speed. Therefore, a static balance and a dynamic balance need to be kept to minimize vibration of an apparatus. In the first embodiment, even if the balances are kept in a state in which the detachable portion 6b is once attached to the fixing portion 6a, the detachable portion 6b needs to be attached to the same fixing portion 6a as before in the case where the same detachable portion 6b is again used after once being detached. Therefore, parts of the apparatus can be easily managed and handled in the second embodiment in which every impact pins 6 are integrally fixed to the impact pin fixing ring 6e.

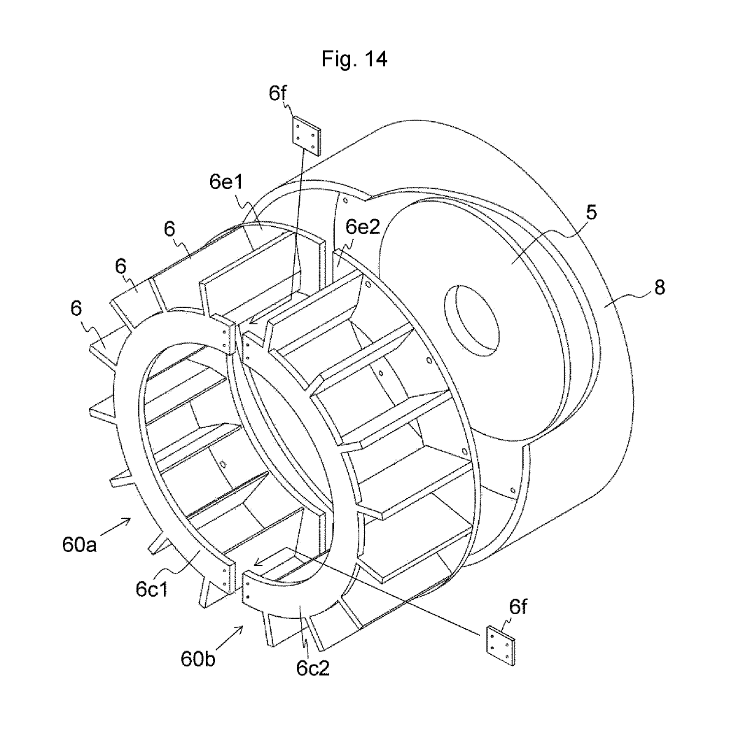

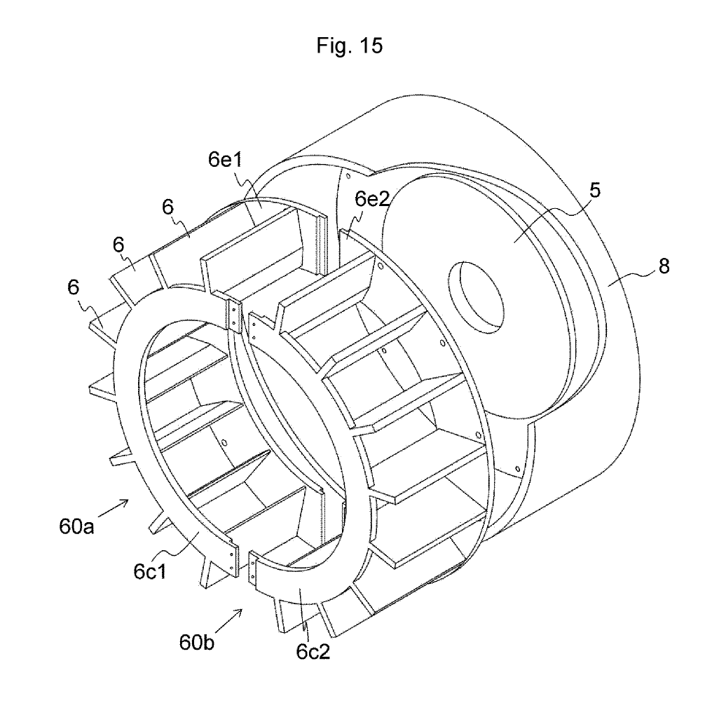

As the powder processing apparatus 1 becomes large, an impact pin group in which every impact pins 6 are fixed to the impact pin fixing ring 6e becomes heavy, and attachment to and detachment from the rotor 5 might become difficult. In such a case, multiple impact pin groups are formed in which the impact pins 6 are dividedly fixed to an impact pin fixing member in which the impact pin fixing ring 6e is divided into two or three, and the multiple impact pin groups may be attached to the rotor 5 (see FIGS. 14 and 15).

FIG. 14 illustrates an example of the impact pin group having two-divided structure (a first impact pin group 60a and a second impact pin group 60b). In this case, the fixing ring 6c and the impact pin fixing ring 6e have a divided structure. A member on a side of the first impact pin group 60a of the fixing ring 6c is a first fixing ring member 6c1. A member on a side of the second impact pin group 60b is a second fixing ring member 6c2. A member on a side of the first impact pin group 60a of the impact pin fixing ring 6e is a first impact pin fixing ring member 6e1. A member on a side of the second impact pin group 60b is a second impact pin fixing ring member 6e2.

In this case, in order to prevent that the first impact pin group 60a and the second impact pin group 60b are bent in a radial direction caused by centrifugal force generated by a high-speed rotation of the rotor 5, it is desirable that the first fixing ring member 6c1 and the second fixing ring member 6c2 are detachably fixed such as by screwing with a covering plate 6f at a portion contacting each other (a bolt and a nut of a screw member are not illustrated).

A part of the contact portions of the first fixing ring member 6c1 and the second fixing ring member 6c2 may be overlapped in an axial direction without using the covering plate 6f, and the overlapped portion may be screwed (see FIG. 15, a screw member is not illustrated). FIG. 15 illustrates an example in which contact portions of the first impact pin fixing ring member 6e1 and the second impact pin fixing ring member 6e2 also have an overlapped shape.

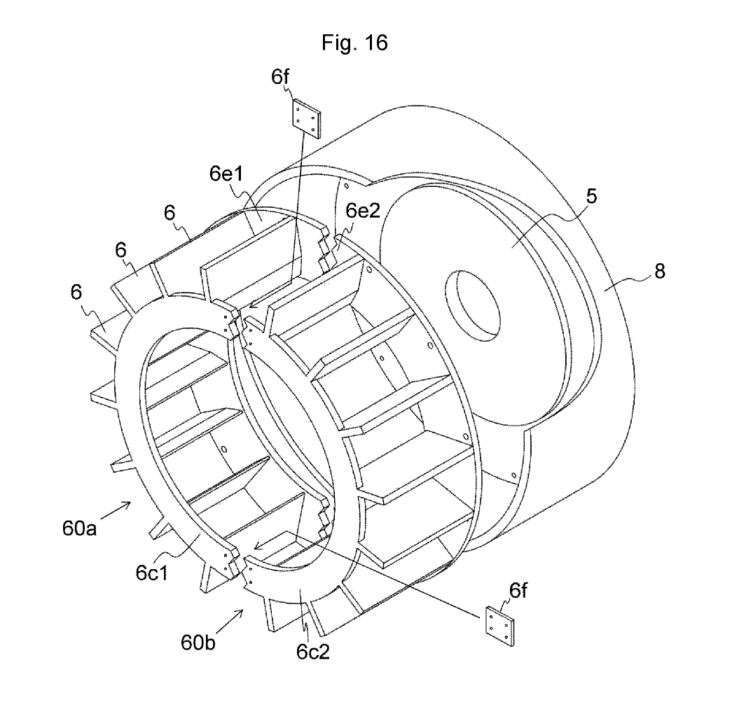

Further, to prevent that the first impact pin group 60a and the second impact pin group 60b are easily detached, a contacting portion (the first fixing ring member 6c1 and the second fixing ring member 6c2, the first impact pin fixing ring member 6e1 and the second impact pin fixing ring member 6e2) may have a shape capable of interdigitating (for example, a shape cut in a zigzag shape and a shape cut in an uneven shape) (see FIG. 16, and a screw member is not illustrated).

Further, the sectional surface configuration views in FIGS. 3, 4, 5, and 11 illustrate the impact pins 6 viewed in front, and the impact pins 6 positioned on a back side are omitted. Furthermore, the sectional surface configuration views in FIGS. 3, 4, and 11 are illustrated so that the inlet 12a can be viewed to indicate circulating flow in the circulation circuit 12. In fact, as illustrated in FIG. 1, the inlet 12a is positioned at a deep position from a sectional surface. In perspective views in FIGS. 6, 9, 12 to 16, the modified powder discharge port, the outlet 12b, and the first jacket 21a are omitted.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE SIGNS LIST

1 powder processing apparatus
2 main body casing
3 rear cover
4 front cover
5 rotor
6 impact pin
6a fixing portion
6a2 groove
6a3 tap hole for fixing detachable portion
6b detachable portion
6b1 tip portion
6b2 engaging portion
6b3 screw hole penetrating tip portion and engaging portion
6c fixing ring
6c1, 6c2 first fixing ring member, second fixing ring member
6e impact pin fixing ring
6e1, 6e2 first impact pin fixing ring member, second impact pin fixing ring member
6f covering plate
7 rotating shaft
8 collision ring
9 discharge port opening/closing valve
10 valve shaft
11 actuator
12 circulation circuit
12a inlet
12b outlet
13 material hopper
14 material supply chute
15 supply port opening/closing valve
17 modified powder discharge pipe
18 powder collector
19 preprocessor
20 material weighing feeder
21a first jacket
21b second jacket
60a, 60b first impact pin group, second impact pin group
A impact chamber

1. A powder processing apparatus, comprising:
a rotor rotating around a horizontal shaft;
multiple impact pins radially attached on a front surface of the rotor, each of the impact pins having a blade shape; and
a collision ring covering a side surface of the rotor in which the impact pins are attached, the collision ring being peripherally disposed along an outermost raceway surface of the impact pins, wherein
apart of members included in the impact pin is detachably attached to the other included in the impact pin, which is fixed to the rotor, and the part of the members is exchangeable with other type(s) of detachable part, to adjust a distance between the impact pins and the collision ring or
an impact pin group integrating the impact pins is detachably attached to the rotor, and the impact pin group is exchangeable with other type(s) of impact pin group, to adjust a distance between the impact pins and the collision ring.

2. The powder processing apparatus according to claim 1, wherein the impact pin includes:
a fixing portion fixed to the rotor; and
a detachable portion detachably attached to the fixing portion,
wherein the detachable portion is the part of members included in the impact pin, and the fixing portion is the other included in the impact pin; and
wherein the detachable portion is exchangeable with other type(s) of detachable portion having different length in a radial direction of the rotor.

3. The powder processing apparatus according to claim 2, wherein the fixing portion extends parallel to an axial direction of a rotating shaft of the rotor and comprises a groove engaged with the detachable portion, and the groove has a sectional shape in which an opening is narrower than a bottom.

4. The powder processing apparatus according to claim 2, wherein a cooling mechanism is provided in the rotor and the fixing portion.

5. The powder processing apparatus according to claim 1, wherein an impact pin group is formed in which one ends of the multiple impact pins are fixed to an impact pin fixing member, the impact pin fixing member is detachably attached to the rotor; and
wherein the impact pin group is exchangeable with other type(s) of impact pin group in which the impact pins have different lengths in a radial direction of the rotor.

6. The powder processing apparatus according to claim 1, wherein each one ends of the impact pins on a side opposite to a side facing the rotor is fixed to a fixing ring.
